(19) United States
(12) Patent Application Publication
(10) Pub. No.: US 2016/0271974 A1
(43) Pub. Date: Sep. 22, 2016

(54) SURFACE TREATMENT FOR PORTABLE GRAPHIC

(71) Applicants: Ralph Giammarco, New Berlin, WI (US); Michael Kolman, West Allis, WI (US)

(72) Inventors: Ralph Giammarco, New Berlin, WI (US); Michael Kolman, West Allis, WI (US)

(21) Appl. No.: 15/166,494

(22) Filed: May 27, 2016

Related U.S. Application Data
(63) Continuation-in-part of application No. 14/960,142, filed on Dec. 4, 2015.
Application No. 14/960,142 is a continuation-in-part of application No. 13/326,080, filed on Dec. 14, 2011, now abandoned.
(60) Provisional application No. 62/166,783, filed on May 27, 2015.
(60) Provisional application No. 61/528,502, filed on Aug. 29, 2011.

(51) Int. Cl. B41J 11/00

(52) U.S. Cl. CPC B41J 11/0015

(57) ABSTRACT

The present system is a nanometallic transportable graphic with a metallically infused target surface adhesion layer (TSAL). The metal infused in the TSAL creates a nano-ionic bond force field with the target surface, which enables the transportable graphic to adhere to a wide variety of surfaces. The nanometallic transportable graphic may be applied to and repositioned on any surface capable of forming a nano-ionic bond. A surface treatment formulation is described which can be applied to any solid surface to provide an interface between the nanometallic transportable graphic and a target surface that would otherwise be unsuitable. The surface treatment allows the nanometallic transportable graphic to form a stable bond and be repositioned.

### CROSS-REFERENCE TO RELATED APPLICATIONS

This application claims the benefit of priority to U.S. Provisional Application No. 62/166,783, titled “Surface Treatment for Portable Graphic,” filed on May 27, 2015. This application is a continuation-in-part of U.S. patent application Ser. No. 14/960,142, titled “Nanometallic Transportable Graphic System,” filed on Dec. 4, 2015, which is a continuation-in-part of U.S. patent application Ser. No. 13/326,080, titled “Nanometallic Transportable Graphic System,” filed on Dec. 14, 2011, which claims the benefit of priority to U.S. Provisional Application No. 61/528,502, titled “Transportable Graphic and System,” filed on Aug. 29, 2011. All of the above applications are hereby incorporated by reference in their entirety.

### FIELD OF INVENTION

The present invention relates to the field of selectively attachable printed graphics and more specifically to a repositionable graphic apparatus to secure and conform the graphic to a target surfaces by enhancing bonding properties of the surface and the graphic medium.

### BACKGROUND OF THE INVENTION

Nanometallic transportable graphics allow a user to print a single type of material to produce numerous specialty graphics for use on multiple types of surfaces. This versatility minimizes printing downtime and maximizes output. Furthermore, because nanometallic transportable graphics take on the color and texture of the substrate or substrate, heavily textured or embossed surfaces can be decorated with full-color, photographic images and graphics.

However, in certain situations the nanometallic transportable graphics bond too strongly to a surface, preventing removal, or do not bond sufficiently to the surface. In other conditions, the nanometallic transportable graphics bond to a surface that is too sharply textured, resulting in damage to the graphic.

Some surface treatments, such as use of an epoxy adhesive, may prevent the graphic from detaching, but do not allow later removal of the graphic. Furthermore, it is desirable that the surface treatments be composed of entirely natural organic substances, easily dispensed, non-toxic and hypoallergenic to skin, free of water, surfactants, wetting agents, waxes and volatile solvents, capable of being odorless or having an added fragrance, stable for long-term applications, and non-drying.

Because this treatment will be used with printed material, it must not induce curl or yellowing in media, or contain components that accelerate ink fading, such as free radicals. Since the graphic must be repositionable, the treatment must be easily removed and cleaned, repositionable and capable of reapplication. The treatment must adhere to a wide variety of surfaces, such as outdoor surfaces, be capable of being formulated for advanced (more demanding) applications, utilize cohesive attachment as primary attachment method, be able to applied by a variety of methods and be capable of being used as an overcoat.

There is an unmet need for a graphic media system with a surface treatment that allows a graphic to be placed on a wide variety of surfaces and then later repositioned on that same or a different surface.

### BRIEF SUMMARY OF THE INVENTION

The present invention is a nanometallic transportable graphic system featuring a nanometallic transportable graphic apparatus with a metallically infused target surface adhesion layer (TSAL) bound to a metallically infused protection layer. The metal nanoparticles create a nano-ionic bond force field, which enables the nanometallic graphic apparatus to adhere to any target surface. The system also includes a surface treatment formulation for use with solid surfaces incapable of forming a nano-ionic bond force field or solid surfaces that form so strong a nano-ionic bond force field as to make repositioning the metallically infused target surface adhesion layer difficult. The surface treatment is a combination of petrolatum, mineral oil, and paraffin wax.

### BRIEF DESCRIPTION OF SEVERAL VIEWS OF THE DRAWINGS

FIG. 1 illustrates a highly magnified view of prior art contact points of a nanometallic transportable graphic and a target surface.

FIG. 2a illustrates an exemplary nanometallic transportable graphic binding to a target surface.

FIGS. 2b and 2c show cross-sectional views of an exemplary nanometallic transportable graphic binding to a carrier and to a target surface.

FIGS. 3a and 3b show individual layers of an exemplary nanometallic graphic having a single layer and multiple layers, respectively.

FIGS. 4a and 4b illustrate a nanometallic transportable graphic in use with an effects layer.

FIG. 5 is a flow chart illustrating an exemplary method for creating and applying a nanometallic graphic.

### TERMS OF ART

As used herein, the term “electromagnetic binding surface” means any surface, regardless of materials, contours and porosity, which is sufficiently free from solid particulate matter (e.g., impurities and dust) and liquids to allow the formation of a nano-ionic bond force field. The electromagnetic binding surface may include a surface treatment.

As used herein, the term “ink absorption” refers to the ability of a material of one state, such as a solid, to incorporate ink in a second state, such as liquid.

As used herein, the term “ink retention” refers to the ability of a material to continually possess or hold ink. Ink retention is measured using any method known in the art, including the cross-hatch adhesion test.

As used herein, the term “metallic particles” means particles of metals including, but not limited to, copper, silver, platinum, zinc, zirconium, gold, iridium, metal alloys and combinations of these metallic particles and other alloys.

As used herein, the term “metallically infused” means having a composition in which one or more metallic particles are dispersed or suspended.

As used herein, the term “metallically infused target surface adhesion layer (TSAL)” means a layer constructed of a polymer infused with metallic particles including, but not limited to, copper, silver, platinum, zinc, zirconium, gold, iridium, metal alloys and combinations of these metallic particles and various other alloys. A metallically infused TSAL bonds inks or toners and a target surface.

As used herein, the term “metallically infused effects layer” means a layer containing an aesthetic effect, such as a background color(s), glitter, metallic finish, pearlization, or other effect, infused with metallic particles including, but not limited to, copper, silver, platinum, zinc, zirconium, gold, iridium, metal alloys and combinations of these metallic particles and various other alloys. A metallically infused effects layer provides a background layer to a completed nanometallic transportable graphic.

As used herein, the term “metallically infused protection layer” means a layer constructed from polymer and infused with metallic particles including, but not limited to, copper, silver, platinum, zinc, zirconium, gold, iridium, metal alloys and combinations of these metallic particles and various other alloys. A metallically infused protection layer protects a metallically infused target surface adhesion layer and any bound inks from mechanical, chemical and environmental degradation.

As used herein, the term “nano-ionic bond force field” means an ionic bond created by the presence of nanometallic particles in one surface that bond to the nanometallic particles in another surface without the use of adhesive. A nano-ionic bond force field creates a physical bond between the surfaces.

As used herein, the term “nano-ionic bond” refers to a physical bond between a first surface and the surface of a substance having a nano-ionic bond force field.

As used herein, the term “nanometallic particles” means a metallic particle having a size of less than approximately 100 nm.

As used herein, the term “polyacrylate” means a material created of acrylate polymers. Polyacrylate is usually transparent and has some elasticity.

As used herein, the term “polyester” means a polymer in which the polymer units are linked by ester groups.

As used herein, the term “polyethylene” means a polymer made by polymerizing ethylene.

As used herein, the term “polyolefin” means a polymer created from an olefin, or alkene, as a monomer.

As used herein, the term “polyurethane” means a material created by a polymer chains containing a plurality of organic units joined by carbonate (urethane) links. Polyurethane is usually elastic and durable and experiences less wear than other similar materials.

As use herein, the term “target surface” means a surface having an electromagnetic binding surface on which a printed graphic is deposited.

### DETAILED DESCRIPTION OF THE INVENTION

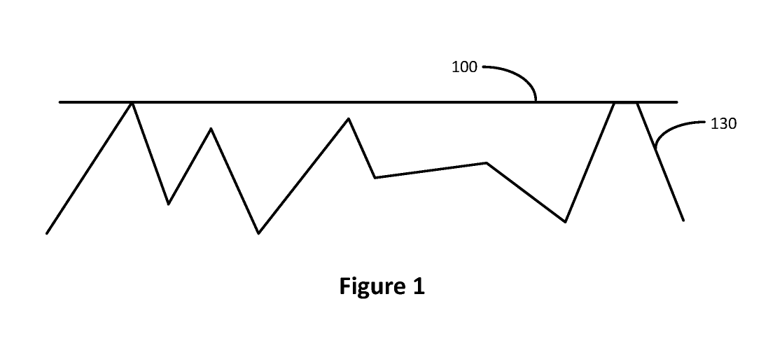

FIG. 1 illustrates a highly magnified view of prior art contact points of a nanometallic transportable graphic 100 and a target surface 130. These contact points do not provide sufficient contact between nanometallic transportable graphic 100 and target surface 130 to allow nanometallic transportable graphic 100 to bond to target surface 130.

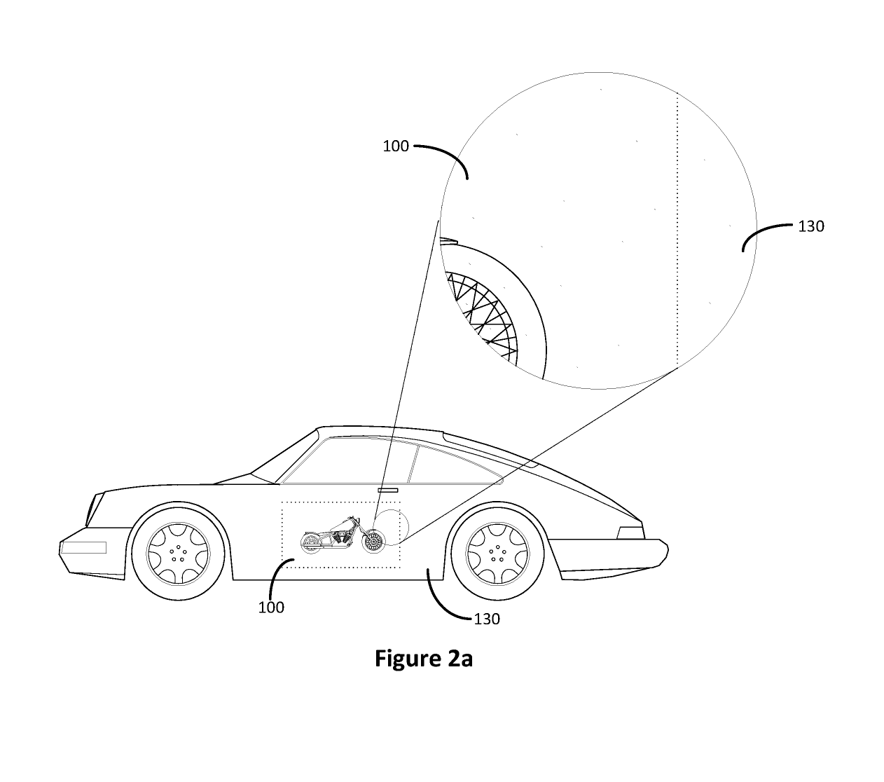

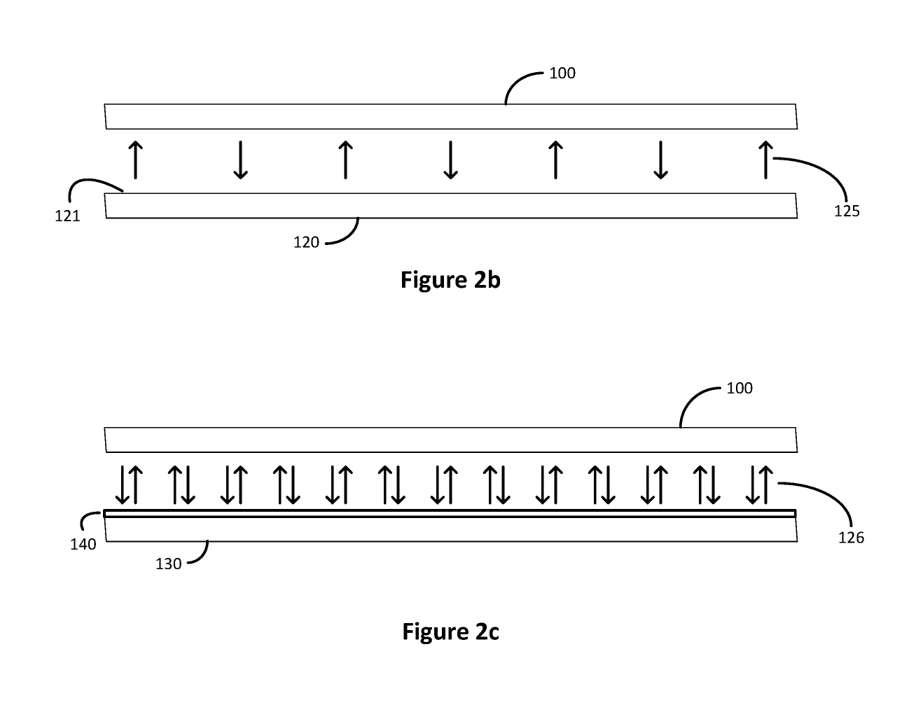

FIG. 2a illustrates an exemplary nanometallic transportable graphic 100 binding to target surface 130. Nanometallic transportable graphic 100 binds to target surface 130, an electromagnetic binding surface that in the exemplary embodiment shown is on a car. Target surface 130 is smooth, and nanometallic transportable graphic 100 conforms to the smooth surface of target surface 130 to create a seamless look along the car, even in areas where nanometallic transportable graphic 100 is bound. In the exemplary embodiment shown in FIG. 2a, nanometallic transportable graphic 100 is an image of a motor cycle on a clear background. The entirety of nanometallic transportable graphic 100 mimics the surface texture of target surface 130, creating the effect that the motorcycle image on nanometallic transportable graphic 100 is one continual surface with target surface 130.

In the exemplary embodiment shown in FIG. 2a, no adhesive or other treatment is necessary to apply the nanometallic transportable graphic 100 to target surface 130. The electromagnetic binding surface of target surface 130 contains metallic particles, which creates a strong non-chemical bond between target surface 130 and nanometallic transportable graphic 100, which is infused with nanometallic particles. No adhesive or other treatment is necessary for other electromagnetic binding surfaces containing metallic coatings or metal particles.

In the exemplary embodiment shown in FIG. 2a, the physical bond created between nanometallic transportable graphic 100 and target surface 30 reinforces the strength and structure of nanometallic transportable graphic 100 while allowing nanometallic transportable graphic 100 to maintain its flexibility and elastic qualities. For example, exemplary nanometallic transportable graphic 100 shown in FIG. 2a has dual orientation, meaning nanometallic transportable graphic 100 stretches equally in all directions. Nanometallic transportable graphic 100 can therefore cover irregular surfaces without tearing or interfering with the overall shape of the image. Nanometallic transportable graphic 100 may also be applied using physical pressure.

FIG. 2a illustrates an exemplary nanometallic transportable graphic 100 binding to a smooth target surface 130 that also contains metallic particles. However, in further embodiments, nanometallic transportable graphic 100 may bind to a wide variety of target surfaces 130, including porous and non-porous surfaces, smooth surfaces, rough surfaces, irregular surfaces, and surfaces with our without metallic particles. The nanometallic particles embedded in nanometallic transportable graphic 100 are capable of forming a first nano-ionic bond force field 126 with any solid target surface 130 or target surface 130 can be treated as described in this disclosure to accept and bond with nanometallic transportable graphic 100.

While nanometallic transportable graphic 100 does not require adhesives or other treatments to stick to target surfaces 130, it may be desirable to use adhesives or treatments, such as the application of heat, to help nanometallic transportable graphic 100 tightly conform to the surface texture of a target surface. In further exemplary embodiments, target surface 130 may be cleaned of any particulate matter or liquids in order to allow a first nano-ionic bond force field 126 to form between nanometallic transportable graphic 100 and target surface 130.

While adhesives and other binding treatments are not necessary, in some exemplary embodiments, adhesives or treatments may be desired to more securely apply nanometallic transportable graphic 100 to certain surfaces. For example, in some exemplary embodiments, adhesives, such as tape, glues, or epoxies, may be beneficial in securing nanometallic transportable graphic 100 more durably. In still further exemplary embodiments, treatments, such as the application of heat, may be beneficial in securing nanometallic transportable graphic 100. However, nanometallic transportable graphic 100 is capable of forming a first nano-ionic bond force field 126 with target surface 130 to allow nanometallic transportable graphic 100 to stick to target surface 130 without adhesives or other treatments.

In the exemplary embodiment, the electromagnetic binding surface making up target surface 130 to which the nanometallic transportable graphic 100 is to be attached is of a character such that adhesion of nanometallic transportable graphic 100 to target surface 130 may be too strong to allow repositioning of nanometallic transportable graphic 100. In other embodiments, the electromagnetic binding surface making up target surface 130 may be too weak to hold nanometallic transportable graphic 100 in place permanently due to surface irregularities or other factors.

Table 1 shows the chemical composition of an exemplary embodiment of a surface treatment 140, which can be applied to a wide variety of target surfaces 130, and used in connection with the exemplary embodiment of nanometallic transportable graphic 100. The surface treatment 140 of the exemplary embodiment can be prepared by mixing the chemical components using a high torque mixer. The function of the surface treatment 140 is to provide an interface between nanometallic transportable graphic 100 and a target surface 130 that would otherwise be unsuitable for placement of nanometallic transportable graphic 100.

TABLE 1

| | | Exemplary |
|---|---|---|
| | Effective range | embodiment |
| Chemical | weight percent | weight percent |
| Petrolatum | 100-20 | 70 |
| Mineral Oil | 80-0 | 5 |
| Paraffin Wax | 80-0 | 25 |
| Fragrance | Trace to none | Trace to none |

Petrolatum is a semi-solid mixture of hydrocarbons, also known as petroleum jelly or soft paraffin.

A mineral oil is any colorless and odorless oil. Suitable oils include a commercially available mixture of alkanes typically in the C-15 to C-40 range, available from non-vegetable sources such as, but not limited to, petroleum distillates. Suitable mineral oils may also be any commercially available liquid polymerized siloxane with organic side chains formed with a backbone of alternating silicon and oxygen atoms.

Paraffin wax is a commercially available white or colorless soft solid derived from petroleum. Paraffin wax is a mixture of hydrocarbons containing between 20 and 40 carbon atoms.

In the exemplary embodiment, surface treatment 140 can be applied to target surface 130 to which the nanometallic transportable graphic 100 is desired to be placed. Surface treatment 140 can be applied in the exemplary embodiment with a brush or flat applicator such as a knife or trowel. Surface treatment 140 has the ability to conform to an irregular target surface 140, and provide appropriate repositioning capabilities for nanometallic transportable graphic 100. Surface treatment 140 uses cohesive attachment as its primary attachment method.

Surface treatment 140 also exhibits the advantages that it is composed of 100% natural organic substances, is free of water content, surfactants, wetting agents, waxes, and volatile solvents, and contains no components such as free radicals or oxidizing agents to accelerate ink fading. Surface treatment 140 is hypoallergenic and able to be allowed by the FDA for direct skin contact, and is odorless, except for any trace fragrances added. Not only can surface treatment 140 change phases from solid to liquid and back again, it will not dry out over an extended time open to the air before application, exhibits long term stability, has no known adverse effects on the environment, and is not toxic when used as described herein. Surface treatment 140 is easily dispensed and is easily cleaned, capable of removal on demand.

Surface treatment 140 will not induce curl in transportable graphic material, allows nanometallic transportable graphic 100 to be repositioned multiple times or to be re-applied after having been placed on another surface, and adheres to a wide variety of target surfaces 130. Because surface treatment 140 is resistant to water, wind, and normal outside temperature fluctuations, it is capable of being used as an overcoat to protect nanometallic transportable graphic 100 from water, wind, and outside temperature fluctuations and can be used in both interior and exterior applications. Surface treatment 140 is capable of being formulated for advanced or more demanding applications.

FIGS. 2b and 2c show a cross-sectional view of an exemplary nanometallic transportable graphic 100 binding to a carrier 120 and to a target surface 130. As illustrated in FIG. 2b, nanometallic transportable graphic 100 binds to carrier component 120 with release surface 121. Nanometallic transportable graphic 100, and in some exemplary embodiments carrier component 120, is infused with nanometallic particles, creating a second nano-ionic bond force field 125 between nanometallic transportable graphic 100 and carrier component 120.

Carrier component 120 functions as a base layer which stabilizes nanometallic transportable graphic 100 during the printing process. Release surface 121 is specifically designed to be easily disengaged from nanometallic transportable graphic 100 while still providing a stable and uniform surface adhesion. In some embodiments, release surface 121 may be designed with a low concentration of nanometallic particles in order to easily disengage nanometallic transportable graphic 100.

In some exemplary embodiments, release layer 121 may be specifically designed for use with smooth or embossed finishing layers 30 (not shown) to create a gloss or matte finished product.

FIG. 2c illustrates an exemplary nanometallic transportable graphic 100 binding to target surface 130 treated with surface treatment 140. Nanometallic transportable graphic 100, and in some exemplary embodiments target surface 130, re infused with nanometallic particles, creating second nano-ionic bond force field 125. As illustrated in FIGS. 2b and 2c, first nano-ionic bond force field 126 is stronger than second nano-ionic bond force field 125, which means nanometallic transportable graphic 100 binds more tightly to target surface 130 than carrier component 120.

In some exemplary embodiments, second nano-ionic bond force field 125 and first nano-ionic bond force field 126 are resistant to temperature, moisture, acid, pressure and solvents, allowing nanometallic transportable graphic 100 to securely bind to carrier component 120 or target surface 130. However, second nano-ionic bond force field 125 allnd first nano-ionic bond force field 126 may be interrupted by certain forces or substances in order to remove nanometallic transportable graphic 100 from carrier component 120 and target surface 130. For example, in some exemplary embodiments, second nano-ionic bond force field 125 and first nano-ionic bond force field 126 may be interrupted by certain physical means, including, but not limited to, certain fluids or forces stronger than the attractive force creating second nano-ionic bond force field 125 and first nano-ionic bond force field 126.

In the exemplary embodiments shown in FIGS. 2b and 2c, nanometallic transportable graphic 100 and carrier component 120 may contain a plurality lof metallic particles distributed throughout their volumes. In some exemplary embodiments, metallic particles may be evenly or unevenly distributed. In further exemplary embodiments, metallic particles may be contained within individual layers of nanometallic transportable graphic 100.

In the exemplary embodiments described, metallic particles are of the same substance and oriented in the same direction. In further exemplary embodiments, metallic particles may be oriented in different directions. In still further exemplary embodiments, nanometallic transportable graphic 100 may contain nanometallic particles of different substances. For example, nanometallic particles may be copper, silver, platinum, zinc, zirconium, gold, iridium, metal alloys and combinations of these metallic particles and various other alloys.

In exemplary embodiments where metallic particles are contained within layers of nanometallic transportable graphic 100, each layer may contain a different type of metallic particle, different concentration of metallic particles and/or different orientation or distribution of metallic particles. In some exemplary embodiments, metallic particles may be specifically chosen to help bind nanometallic transportable graphic 100 to a specific target surface.

In the exemplary embodiments described, the concentration of nanometallic particles in the layers of a nanometallic transportable graphic 100 range between 10 parts-per-million (ppm) to 100 ppm. In some embodiments, the concentration of nanometallic particles may be varied depending on the bonding strength, or peel force (measured in grams per inch), desired and the bonding surface. For example, as the concentration of nanometallic particles increases, the strength of the first nano-ionic bond force field 126 increases for a given surface. However, the strength ceases to increase once a maximum concentration is reached. The resulting values create an adhesion curve. The specific concentration of nanometallic particles for a transportable graphic 100 may be selected based on the adhesion curve for a desired target surface 130.

Depending on the nanometallic particles present in nanometallic transportable graphic 100, carrier component 120 and/or target surface 130, second nano-ionic bond force field 125 and first nano-ionic bond force field 126 may form more readily at certain temperatures. In the exemplary embodiments described, second nano-ionic bond force field 125 and first nano-ionic bond force field 126 are readily formed and maintained at temperatures between −40 and 400 degrees Fahrenheit without the use of additional adhesives or other treatments. In some exem;plary embodiments, second nano-ionic bond force field 125 and first nano-ionic bond force field 126 may form outside of that temperature range if adhesives or treatments are used.

In addition to creating second nano-ionic bond force fields 125 and first nano-ionic bond force fields 126, nanometallic particles distributed throughout nanometallic transportable graphic 100 enhance the durability of inks. The specific polymer or polymers used to create nanometallic transportable graphic 100 may also be selected for its ability to absorb and retain ink. For example, polyacrylate and polyurethane are two polymers known in the art which may be used for nanometallic transportable graphic 100.

In some exemplary embodiments, the specific polymer or polymers used may also be selected for their ability to manifest high heat, which is important for bonding and conforming to target surfaces.

In various embodiments, nanometallic transportable graphic 100 may be used to adhere any image to any surface using any printer known in the art, including but not limited to digital and traditional presses, laser printers and aqueous, solvent, low-solvent, latex and UV-curable inkjet printers.

In the embodiment shown, nanometallic transportable graphic 100 conforms to the texture of a wide variety of surfaces to which it is applied. While no additional treatment is necessary, depending on the method used to apply it, such as heat, liquid, primer or adhesive, adhesion may be permanent or temporary.

By creating a non-chemical bond using nanometallic particles, it is possible to rotate, flex and reposition nanometallic transportable graphic 100. The nanometallic particles allow nanometallic transportable graphic 100 to be rotated. This non-chemical bond is temporary and may be subsequently be broken and reestablished. The bond may be broken solely by physical or mechanical means, such as physically pulling or separating, as distinguished from chemical means (other than water or physical dilution) known in the art.

Infusion of the nanometallic particles causes nanometallic transportable graphic 100 to remain pliable during the curing process, allowing nanometallic transportable graphic 100 to conform to the substrate's texture and contours. It is critical to use a nanometallically-infused graphic material which as the durability of cured film, but retains the flexibility of uncured film. In the exemplary embodiment described, nanometallic transportable graphic 100 is printed on a thin, nanometallic particle infused film, which remains pliable during curing. The nanometallically-infused graphic medium creates a non-chemical bond with substrates.

In the embodiment shown, the use of nanometallic particles smaller than 75 nm is critical, allowing for greater light transmission and less light absorption. Metallic particles of a larger proportional size would cause the graphics material to darken. Preferably, nanometallic particles will have a size in the critical range of 25 nm to 65 nm.

In the exemplary embodiments described, carrier component 120 is a single-use, disposable carrier. However, in further exemplary embodiments, carrier component 120 may be double-sided or reusable. For example, carrier component 120 may contain layers for nanometallic transportable graphic 100 on both its upper and lower surface. In some embodiments, a double-sided carrier component 120 may contain one side configured to generate a nanometallic transportable graphic 100 with a matte finish, while the other side may be configured to generate a nanometallic transportable graphic 100 with a glossy finish. In further exemplary embodiments, both sides may be configured to provide identical finishes.

In still further exemplary embodiments, carrier component 120 may include a durable, reusable portion with a disposable liner or other surface or layer which is removable from both nanometallic transportable graphic 100 and carrier component 120.

Carrier component 120 is a durable paper layer having a polyolefin, polyester or polyethylene substrate. The substrate diminishes the strength of the second nano-ionic bond force field 125 created between carrier component 120 and nanometallic transportable graphic 100. In further exemplary embodiments, other substrates or coatings may be used to diminish the strength of the first nano-ionic bond force field 126 formed between carrier component 120 and nanometallic transportable graphic 100. For example, polyethylene may be used in other exemplary embodiments, as nanometallic transportable graphic 100 will not stick well to polyethylene.

By diminishing the strength of the second nano-ionic bond force field 125 created between carrier component 120 and nanometallic transportable graphic 100, nanometallic graphic 100 becomes selectively releasable from carrier component 120.

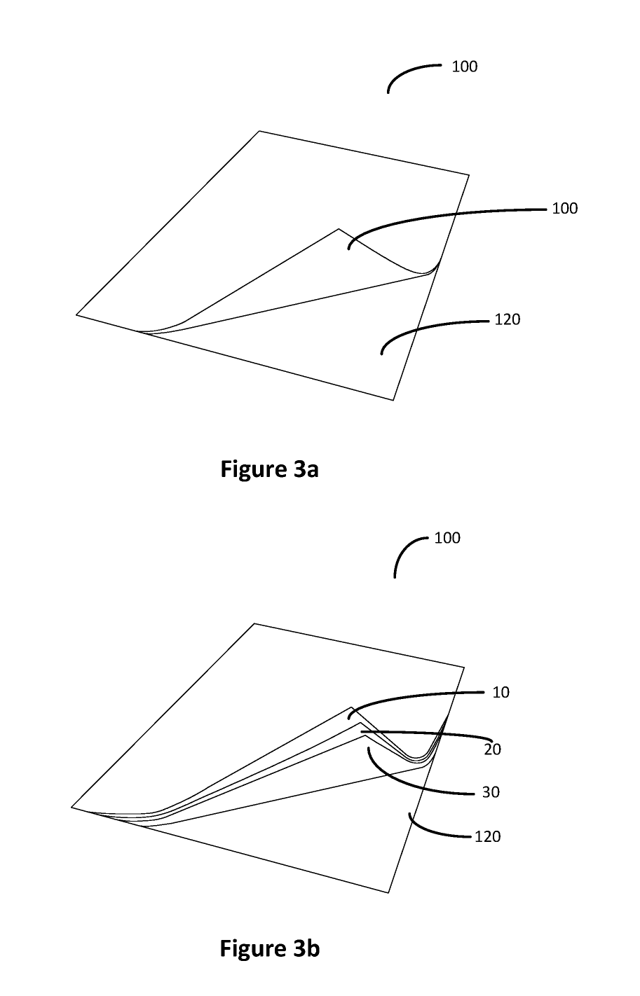

FIGS. 3a and 3b show individual layers of an exemplary nanometallic graphic 100 having a single layer and multiple layers, respectively. As illustrated in FIG. 3a, nanometallic transportable graphic 100 separates from carrier component 120 as a single, thin sheet. However, in the embodiment of FIG. 3b, nanometallic transportable graphic 100 contains multiple layers or coatings while retaining the thinness, flexibility and appearance of a single, thin sheet.

FIG. 3b shows individual layers, which may make up nanometallic transportable graphic 100. As illustrated in FIG. 3b, nanometallic transportable graphic 100 contains printable target surface adhesion layer (TSAL) 10, protection layer 20 and finishing layer 30. While drawn in FIG. 3b as individual, peeled back layers, layers 10, 20 and 30 are sufficiently bound with one another to be one and part of the same sheet making up nanometallic transportable graphic 100. Some exemplary embodiments may omit finishing layer 30 or include additional protective or aesthetic layers.

In the exemplary embodiment shown, printable TSAL 10 and protection layer 20 are metallically infused. Printable TSAL 10 has a non-porous outer surface which receives ink. Printable TSAL 10 is metallically infused, and yet has surface properties compatible with standard ink formulations containing organic or organometallic dyes or pigments and a suitable vehicle. This compatibility allows ink to adhere to the surface of TSAL 10 in a manner known in the printing art.

In some exemplary embodiments, printable TSAL 10 may be patterned or colored. In still further exemplary embodiments, printable TSAL 10 may contain an ink substrate. Inks in an ink substrate may include, but are not limited to solvent-based inks, UV inks, latex inks, flexo inks, offset inks, organometallic inks and combinations of inks. Inks may also be liquid inks or dry toner-style inks.

In other exemplary embodiments, TSAL 10 may have multiple sub-layers to create different color or aesthetic effects or provide additional thickness to nanometallic transportable graphic 100. For example, in some exemplary embodiments, TSAL 10 may contain sub-layers with different ink distributions to produce a color effect.

Protection layer 20 protects printable TSAL 10 from mechanical, chemical and environmental degradation. In the exemplary embodiment shown, protection layer 20 is structured to block ultraviolet light to prevent the ink from fading. In further exemplary embodiments, protection layer 20 may contain additional light-blocking properties. In some exemplary embodiments, nanometallic particles imbedded in protection layer 20 or other layers of nanometallic transportable graphic 100 work to block ultraviolet light. In other exemplary embodiments, commercially available ultraviolet-blocking compounds or formulations may be used alone or in conjunction with nanometallic particles. By blocking ultraviolet light, the life of the ink used in nanometallic transportable graphic 100 is extended.

In some exemplary embodiments, protection layer 20 may include finishing substances. For example, protection layer 20 may have a gloss finish with a light reflectivity index between 120 and 150 gloss units. In other exemplary embodiments, protection layer 20 may be considered a matte finish, with a light reflectivity index between 2 and 20 gloss units.

As illustrated in FIG. 3b, finishing layer 30 is a single layer that directly contacts carrier component 120. Finishing layer 30 helps keep nanometallic transportable graphic 100 loosely bound to and easily removed from carrier component 120. Finishing layer 30 may also provide an aesthetic quality to nanometallic transportable graphic 100, such as a gloss or matte finish. Finishing layer 30 may also aid in creating an ionic bond with a target surface.

In the exemplary embodiment shown, layers 10, 20 and 30 of nanometallic transportable graphic 100 are laminated together to create a single component or sheet. In further exemplary embodiments, layers 10, 20 and 30 may be pressed or otherwise bound to create a single component or sheet.

While in the exemplary embodiment illustrated in FIG. 3b, nanometallic transportable graphic 100 is illustrated as having three layers 10, 20 and 30 which loosely adhere to carrier component 120, in further exemplary embodiments, nanometallic transportable graphic 100 may contain more or fewer layers. In still further exemplary embodiments, some layers may contain sub-layers or components. For example, protection layer 20 may contain a waterproofing component, UV protection component, and/or a museum-grade preservative, among others.

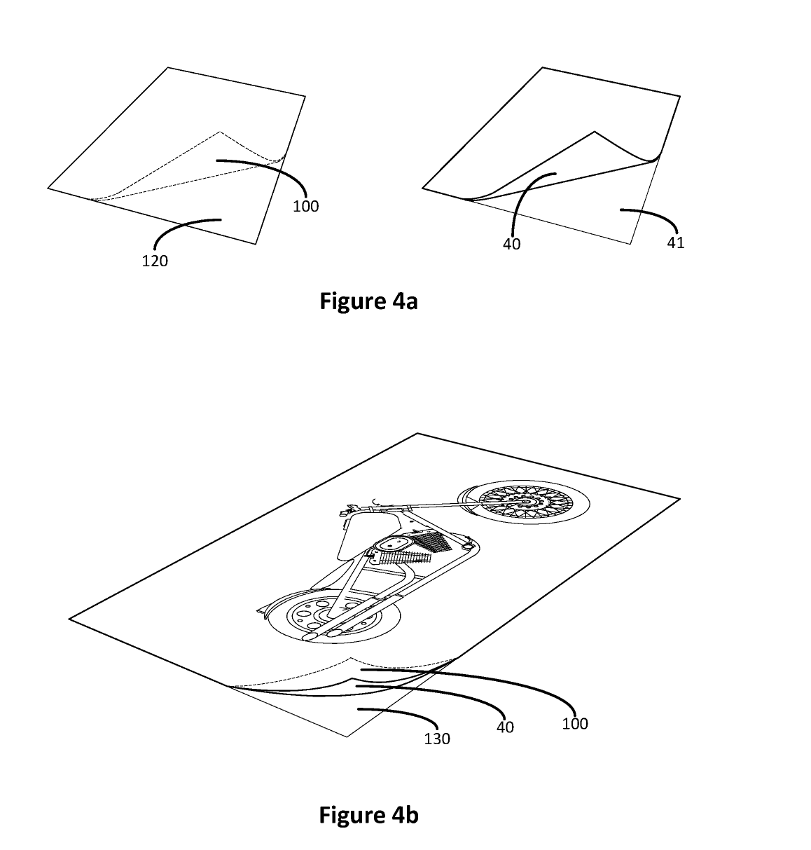

FIGS. 4a and 4b transportable graphic 100 in use with an effects layer 40. As illustrated in FIG. 4a, effects layer 40 is a physically separate layer from nanometallic transportable graphic 100. However, in other embodiments effects layer 40 may be bonded to nanometallic transportable graphic 100 to provide a variety of visual effects.

In the exemplary embodiment shown, effects layer 40 is a metallically infused substrate bound to an effects carrier component 41 through an effects nano-ionic bond force field 45 (not shown), similar to the manner in which nanometallic transportable graphic 100 is stably bound to its carrier 120. Once a graphic image is printed on TSAL 100, nanometallic transportable graphic 100 is removed from its carrier component 120 and placed on effects layer 40. As illustrated in FIG. 4b, effects layer 40 is therefore visible through any portion of nanometallic transportable graphic 100 not containing ink.

In the exemplary embodiment shown, nanometallic transportable graphic 100 creates a strong nano-ionic bond force field 46 (not shown) with effects layer 40, similar to the manner in which nanometallic transportable graphic 100 bonds to target surface 130. In other exemplary embodiments, an adhesive or adhering process may be used to bind nanometallic transportable graphic 100 and effects layer 40.

Because nanometallic transportable graphic 100 is bound to effects layer 40, effects layer 40 becomes the layer which binds to target surface 130. Together, effects layer 40 and target surface 130 create first nano-ionic bond force field 126, releasably joining nanometallic transportable graphic 100 and target surface 130.

In some exemplary embodiments, effects layer 40 creates a colored background or other visual effect (e.g., glitter, metallic finishing, pearlized finishing). In other exemplary embodiments, an effects layer may be provided for thickness and additional stability.

To create and use nanometallic transportable graphic 100, an image is first entered into a computer. Images may be scanned to a computer, digitally designed or transferred to a computer as a file. The image is then printed. Any style of printer may be used, including, but not limited to, a plotter, a desktop printer and an offset press. In further exemplary embodiments, the image may be printed with an offset press without using a computer.

In some exemplary embodiments, nanometallic transportable graphic 100 on carrier 120 may be run through a printer multiple times and receive multiple layers of ink. In some exemplary embodiments, nanometallic transportable graphic 100 may receive as many layers of ink through as many passes through a printer as the printer is capable of. In other exemplary embodiments, it may be desirable to limit the number of layers of ink and passes through a printer to achieve or retain an aesthetic quality.

The image is printed as nanometallic transportable graphic 100 on carrier 120. Once removed from carrier 120, nanometallic transportable graphic 100 may be placed on any target surface 130. The target surface 130 may or may not be treated with surface treatment formulation prior to the application of nanometallic transportable graphic 100. Nanometallic transportable graphic 100 may be of any size or shape and placed on any surface. The size, shape, clarity and resolution of nanometallic transportable graphic 100 are limited only by the properties of the printer used to print nanometallic transportable graphic 100.

Nanometallic transportable graphic 100 is removable from target surface 130. In the exemplary embodiments illustrated, the force required to remove nanometallic transportable graphic 100 from a target surface 130 is between 1 and 200 grams per linear inch width when pulled at 90 degrees. Target surface 130, however, is not damaged by nanometallic transportable graphic 100.

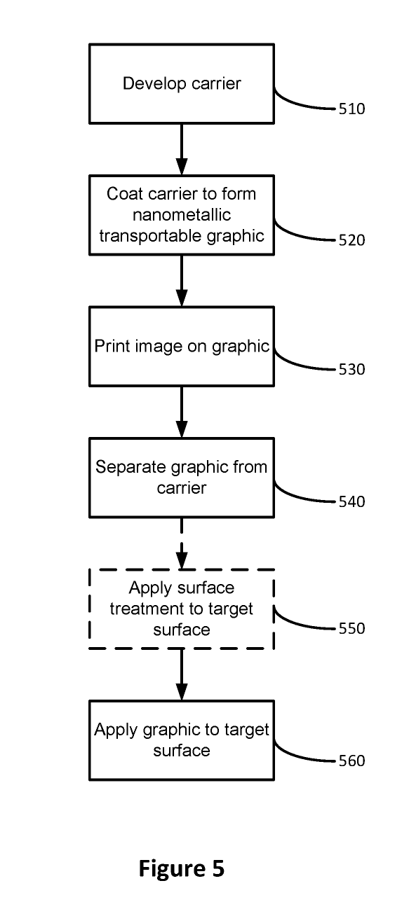

FIG. 5 is a flow chart illustrating an exemplary method for creating and applying nanometallic transportable graphic 100.

Step 510 is the step of developing carrier 120. Carrier 120 must loosely bind to nanometallic transportable graphic 100, but must still bind nanometallic transportable graphic 100 with sufficient strength to carry it through the printing process. Carrier 120 may also be selected based on the type of printer being used or the type of surface finish desired for nanometallic transportable graphic 100.

Carrier 120 must then be coated (Step 520) with the material which will become nanometallic transportable graphic 100. Different finishes, glosses and protective components may be considered when choosing the material that will become nanometallic transportable graphic 100.

Step 530 is printing an image on nanometallic transportable graphic 100. Any printing process known in the art may be used to print nanometallic transportable graphic 100.

Once a image has been printed, nanometallic transportable graphic 100 is separated from carrier 120 (Step 540). Optionally, surface treatment 140 is applied to target surface 130 (Step 550). Then nanometallic transportable graphic 100 is applied to the desired surface (Step 560).

Nanometallic transportable graphic 100 may be applied to any target surface 130 and, while adhesives or other treatments are not necessary to apply nanometallic transportable graphic 100, an adhesive or other treatment may be desired to help nanometallic transportable graphic 100 neatly and strongly adhere to target surface 130. Adhesives or other treatments may also help nanometallic transportable graphic 100 more closely conform to any contours or textures of the target surface 130 to which it is being applied.

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the terms “substantially” or “approximately” as used herein may be applied to modify any quantitative representation that could permissibly vary without resulting in a change in the basic function to which it is related.

What is claimed is:

1. A nanometallic transportable graphic system comprised of:
a nanometallic transportable graphic apparatus having at least one printable, metallically infused target surface adhesion layer (TSAL) having a non-porous outer surface to which ink may be applied in a printing process,
wherein said metallically infused TSAL is integrally bound to at least one metallically infused protection layer; and
at least one user-selected electromagnetic target surface having at least one layer of a surface treatment, wherein said surface treatment comprises a combination of petrolatum, mineral oil, and paraffin wax,
wherein said metallically infused TSAL and said target surface create a first nano-ionic bond force field between said metallically infused TSAL and said target surface.

2. The system of claim 1 wherein said metallically infused TSAL is infused with nanometallic particles smaller than 75 nm.

3. The system of claim 2 wherein said nanometallic particles are selected from the group consisting of copper, silver, platinum, zinc, zirconium, gold, iridium, metal alloys and combinations thereof.

4. The system of claim 2 wherein said nanometallic particles have a size in the range of 25 nm to 65 nm.

5. The system of claim 2 wherein the concentration of said nanometallic particles in said metallically infused TSAL is between 1 ppm and 100 ppm.

6. The system of claim 1 wherein said at least one metallically infused protection layer has a light reflectivity index between 120 and 150 gloss units and is characterized as a gloss finish.

7. The system of claim 1 wherein said at least one metallically infused protection layer has a light reflectivity index between 4 and 20 gloss units and is characterized as a matte finish.

8. The system of claim 1 which further includes a disposable carrier component which adheres to said at least one metallically infused protection layer by creating a second nano-ionic bond force field.

9. The system of claim 8 wherein said first nano-ionic bond force field is stronger than said second nano-ionic bond force field.

10. The system of claim 8 wherein said disposable carrier component includes a paper layer with a polymer substrate, said polymer substrate causing a diminished nano-ionic bond force field to be selectively releasable.

11. The system of claim 10 wherein said polymer substrate is selected from the group consisting of: polyolefin, polyester, and polyethylene.

12. The system of claim 1 wherein said TSAL further includes at least one ink substrate comprised of an ink selected from the group consisting of a solvent ink, UV ink, a latex ink, a flexo ink, an offset ink, organometallic ink and combinations thereof.

13. The system of claim 1 wherein said TSAL further includes an ink substrate comprised of an ink selected from the group consisting of a liquid ink, a dry toner ink, and an aqueous ink jet ink.

14. The system of claim 1 which further includes an optional adhesive layer which is a pressure sensitive layer.

15. The system of claim 1 wherein said TSAL can be bonded to said target surface by applying heat though said at least one metallically infused protection layer or a binding layer.

16. The system of claim 1, wherein said nanometallic transportable graphic apparatus further includes an effects layer, wherein said effects layer is a metallically infused substrate.

17. The system of claim 1, wherein said surface treatment comprises at least 20 percent petrolatum by weight.

18. The system of claim 1, wherein said surface treatment comprises mineral oil of less than 80 percent by weight.

19. The system of claim 1, wherein said surface treatment comprises paraffin wax of less than 80 percent by weight.

20. The system of claim 1, wherein said surface treatment further comprises a fragrance.
